(19) United States
(12) Patent Application Publication
(10) Pub. No.: US 2014/0010915 A1
(43) Pub. Date: Jan. 9, 2014

(54) Wine Fermentation and Oak Extraction Method and Apparatus

(71) Applicant: Edwin L. Barr, Petaluma, CA (US)

(72) Inventor: Edwin L. Barr, Petaluma, CA (US)

(73) Assignee: ECHO BRAVO LLC, Santa Rosa, CA (US)

(21) Appl. No.: 13/646,846

(22) Filed: Oct. 8, 2012

Related U.S. Application Data
(60) Provisional application No. 61/669,302, filed on Jul. 9, 2012.

(51) Int. Cl. C12G 1/022; C12G 1/00

(52) U.S. Cl. 426/15; 99/276

(57) ABSTRACT

Primary fermentation of grape must can be performed in rectangular vessels, such as conventional fruit picking bins, while providing a comparable surface area to volume ratio of toasted or plain oak to barrel fermentation. The oak or any other wood is provided in the form of planks that are supported in a stacked and spaced apart arrangement in a supporting frame that sits within the bin. The frame and oak can be removed together when sufficient oak flavor has been extracted or before pressing the juice from the must to complete secondary fermentation. The wood and or frame can also provide a means to submerse the cap that forms in primary fermentation.

### CROSS REFERENCE TO RELATED APPLICATIONS

The present application claims the benefit of priority to the US provisional patent application of the same title that was filed on Jul. 9, 2012, having application Ser. No. 61/669,302, which is incorporated herein by reference.

### BACKGROUND OF INVENTION

The present invention relates to an apparatus for making wine, and more particularly to an apparatus for flavoring wine with wood extract

Prior methods of enhancing the flavor of wine with wood extract are fermentation and aging in wood, and particularly oak barrels, immersion a particulate form of oak in the wine, such as chips or saw dust, or holding oak planks below the surface of the wine. Alternatively, a concentrated extract of oak flavor extracted from wood can be added to wine. All such processes are commonly refer to as “oaking” wine, because oak is the preferred and predominant wood used for this purpose.

Oak barrels are very expensive due to the hand labor in their fabrication, as well as the precision cutting and joining of oak pieces. Further, during the fabrication process the inside of the barrel is charred lightly, referred to as toasting, as this releases particularly favored taste and olfactory profiles in wine.

Other have suggested various formats for fabricating oak pieces for insertion in metal barrels or tanks, or oak barrels that have lost the ability to provide more extractive flavors form repeated uses. Their use, and particularly the use of particulate form of oak wood, has less than satisfactory results, likely due in part from the difficulty in replicating the surface to volume ratio of a traditional 50-60 gallon barrel. Failure to reproducing replicate this ratio can lead to over extraction of harsh tannins in wine, unless the testing is done rather frequently. Further, one would also need to simulate the level of “toasting” of any wood that is charred outside the normal barrel making process.

Some winemakers prefer to ferment grape must in barrels to add complexity, rather than just store and age wine in the barrels after it is fermented in other containers. This introduces greater variability if attempted with any of the substitutes for oak barrels, as well as additional complexity to the winemaking process. As for oak barrel substitution during fermentation, while wood chips and dust can be added to a primary fermentation. There is a great detail of potential variability that could ruin the inchoate wine. Submerged oak plank or pieces can interfere with the need to repeatedly break up and “punch down” the grape skin cap that forms on the surface of wine during fermentation. The cap being the solid grape skin inflated into a porous soft mass that is lighter than grape juice/wine due to entrapped carbon dioxide formed during fermentation. Since extraction of color and flavor from the skins is an essential part of making red wines, it is important to also control, and at many times extend extraction from this cap forming mass of skins

It is therefore a first object of the present invention to provide low cost method to achieve grape juice or must fermentation in contact with oak and/or toasted oak.

It is another object of the invention to provide a means for a rapid extraction of flavors from the oak, and particularly toasted oak that efficiently utilizes substantially all of the wood surface immersed in the grape juice/must and/or wine and mixtures thereof during fermentation.

It is still a further object to provide a means to “oak” wines that offer great versatility as to the size and dimension of the primary fermentation vessel, and in particular to use ¼, ½, and 1 “ton” harvest bins with open tops as primary ferments for red wine must.

It is still a further object to provide a means for such “oaking” that does not interference with punching down the cap during the primary fermentation of red wines.

It is still a further object to provide a means to “oak” wine at the earliest stage of the winemaking process, that is immediately after “crush” and not be dependent on lead time or order and obtain new oak containers.

It is still a further object to provide a such a means for oaking that permits and more preferably enables a simple means for fermentation with a submerged cap.

It is still a further object to provide a simple and efficient means to evaluate potential barrel fermentation and/or barrel aging with different wood lots and toast levels before committing to barrel production and purchase.

It is still a further object to provide a means to use a mixture of different wood lots and toast levels in a small lot of wine, as well as avoid blending separate lots from small barrels.

### SUMMARY OF INVENTION

In the present invention, a first object is achieved by providing an assembly for flavoring wine during fermentation, the assembly comprising a laterally extending base having at least 3 vertices, a plurality of columns extending upward from the base, each column extending upward proximal to a vertex thereof, a plurality of longitudinally extending wooden planks having holes on opposing ends, said planks being disposed horizontally and supported in a stacked arrangement by adjacent pairs of said columns, which extend through the holes thereof, a means to hold the planks submerged in a fluid, a gripping means attached to the base or frame)

A second aspect of the invention is characterized by such an assembly for flavoring wine during fermentation wherein the planks in adjacent stacks are interlaced such that vertically adjacent planks in the stack extend at about the same angle as the angle between the vertices of said base.

A third aspect of the invention is characterized by a process for fermenting grape must, the process comprising the steps of providing a rectangular vessel capable of retaining fluid, introducing the above assembly in the vessel, filling the vessel with grape must, fermenting the grape must in the presence of the assembly to extract tannins and related flavor components from the wood and flavor the wine the is the product of the step of fermenting.

The above and other objects, effects, features, and advantages of the present invention will become more apparent from the following description of the embodiments thereof taken in conjunction with the accompanying drawings.

### BRIEF DESCRIPTION OF THE DRAWINGS

FIG. 1 is a perspective view of the wood supporting frame for insertion in a rectangular vessel having a square bottom

FIG. 2 is an upper plan view of the Frame in FIG. 1.

FIG. 3 is a lower plan view of the frame in FIGS. 1 and 2.

FIG. 4A is a front elevation of the frame in FIG. 1-3.

FIG. 4B is a side elevation of the frame in FIG. 1-4.

FIG. 5 is a perspective cut-away view of the frame of FIG. 1-4 in a bin.

FIG. 6 is a perspective view of an alternative embodiment of a frame for supporting wood.

FIG. 7 is a perspective view of the alternative embodiment of the frame in FIG. 6 partially loaded with wood planks

FIG. 8 is a perspective view of the components of the frame and wood plank in the embodiment of FIG. 1-4 in the form of a disassembled kit that is loaded in a box for shipment or storage.

FIG. 9 is a cross-sectional elevation of the kit and box in FIG. 8 taken at section line segments A-A.

FIG. 10A-C are respectively plan, front and side elevation views of a preferred embodiment of a wood plank.

FIG. 11A is a cross-sectional elevation of another embodiment of the invention in which the frame includes an upper plate that is perforated to submerge the cap that forms in primary fermentation, whereas FIG. 11B is a partial plan view of the perforated upper plate.

FIG. 12 is a cross-sectional elevation of another embodiment of the invention in which the frame is inverted and the base becomes the perforated upper plate used to submerge the cap that forms in primary fermentation.

### DETAILED DESCRIPTION

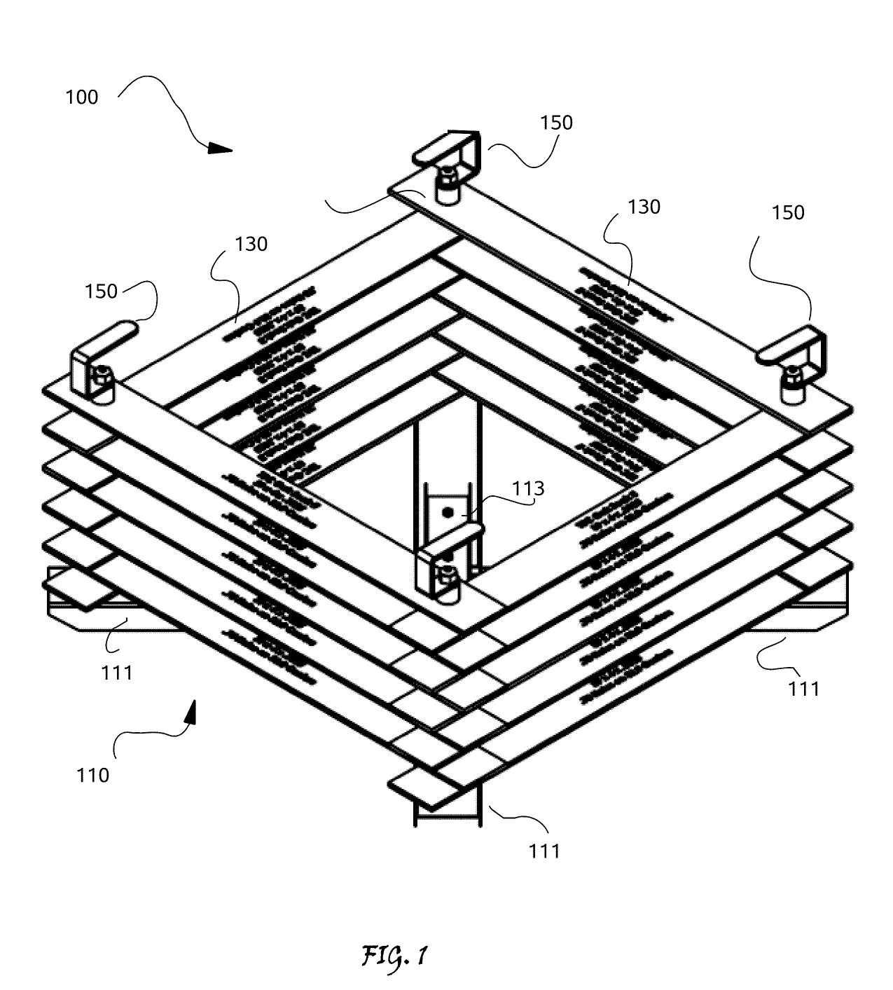

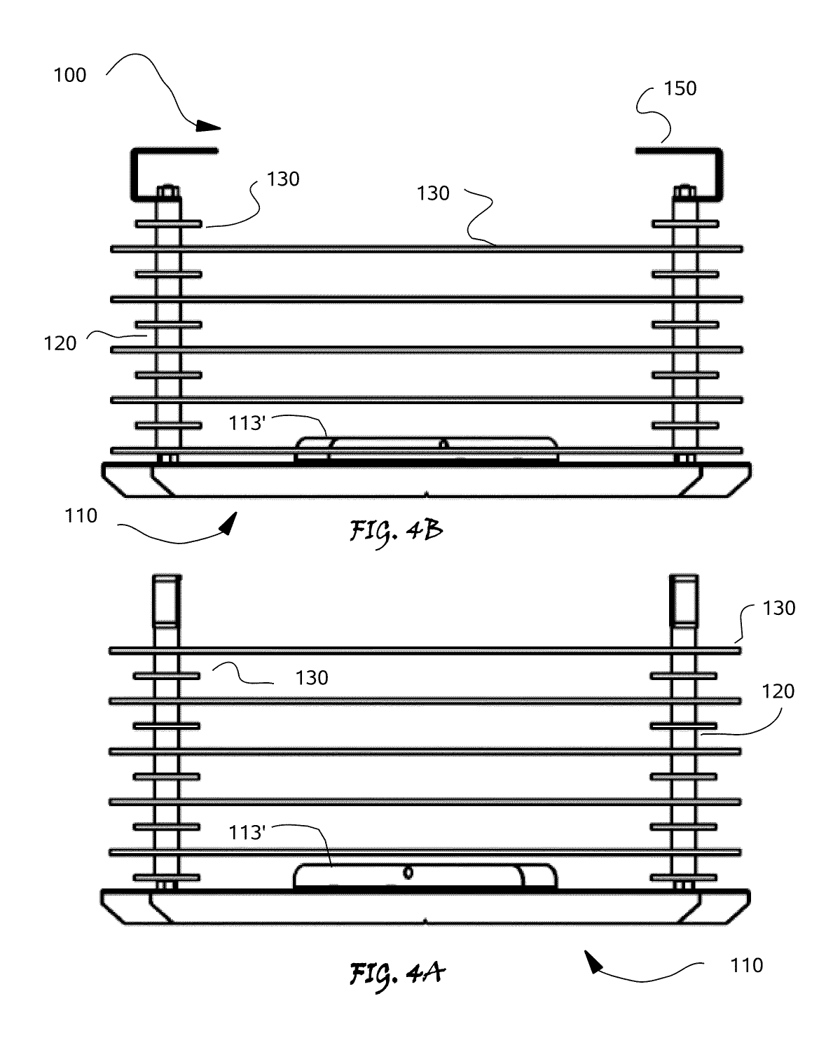

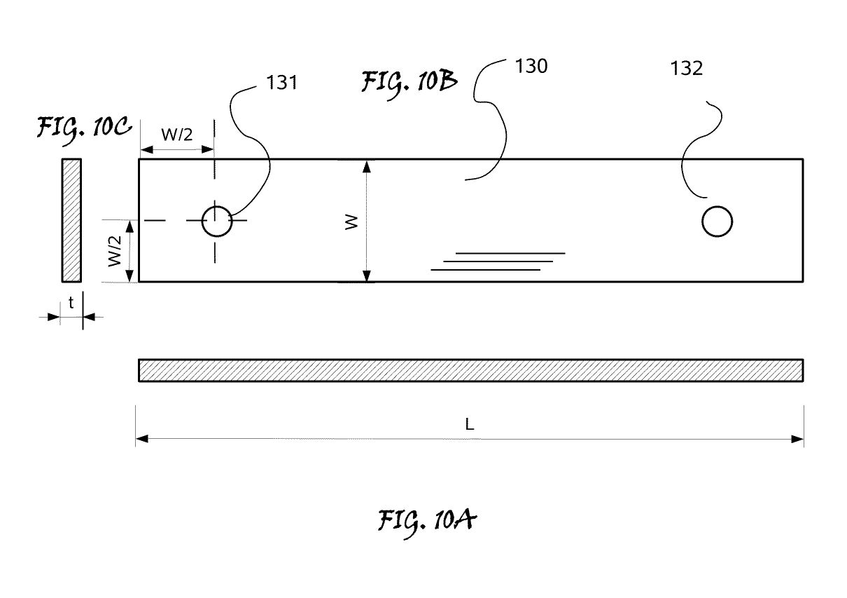

Referring to FIGS. 1 through 12, wherein like reference numerals refer to like components in the various views, there is illustrated therein a new extraction apparatus, generally denominated 100 herein.

In accordance with the present invention the extraction apparatus is a frame like structure having a laterally extending base 110. The base should have at least 3 vertices, but more preferably has 4 to fill the space of a rectangular tank. Further, columns 120 extend upward from their point of attachment to the base that is proximal to the 4 corners or vertices thereof 110a. When the frame is ready for use in a fermenting vessel, it supports a plurality of wooden planks 130 that have holes 131 on opposing ends and are disposed horizontally with the columns extending through the holes.

Preferably, the planks 130 are interlaced as they are layered on the support columns 120 in stack, such that vertically adjacent planks in the stack extend at about the same angle as that between the vertices. That is, when four columns are used to define four vertices in a square or rectangular shape, vertically adjacent stacks are oriented normal or 90 degrees from each other. The orientation of the planks 130 is preferably with the principle plane parallel to the flat bottom of the vessel 501.

There are various optional means maintain the planks 130 submerged in the liquid, that is grape must, juice or wine and mixtures thereof that fills the intervening space with the fermentation vessel. These means include without limitation nuts, washers, pins and cap that are threaded onto the tops of the columns, or otherwise attached after the stacking is completed. In the preferred embodiments these means are handles 150 which attach to the columns 120 above the last plank 130, as discussed below. Alternatively, when the planks are held in place by other than such handles 150, the frame 100 can be gripped by the planks themselves.

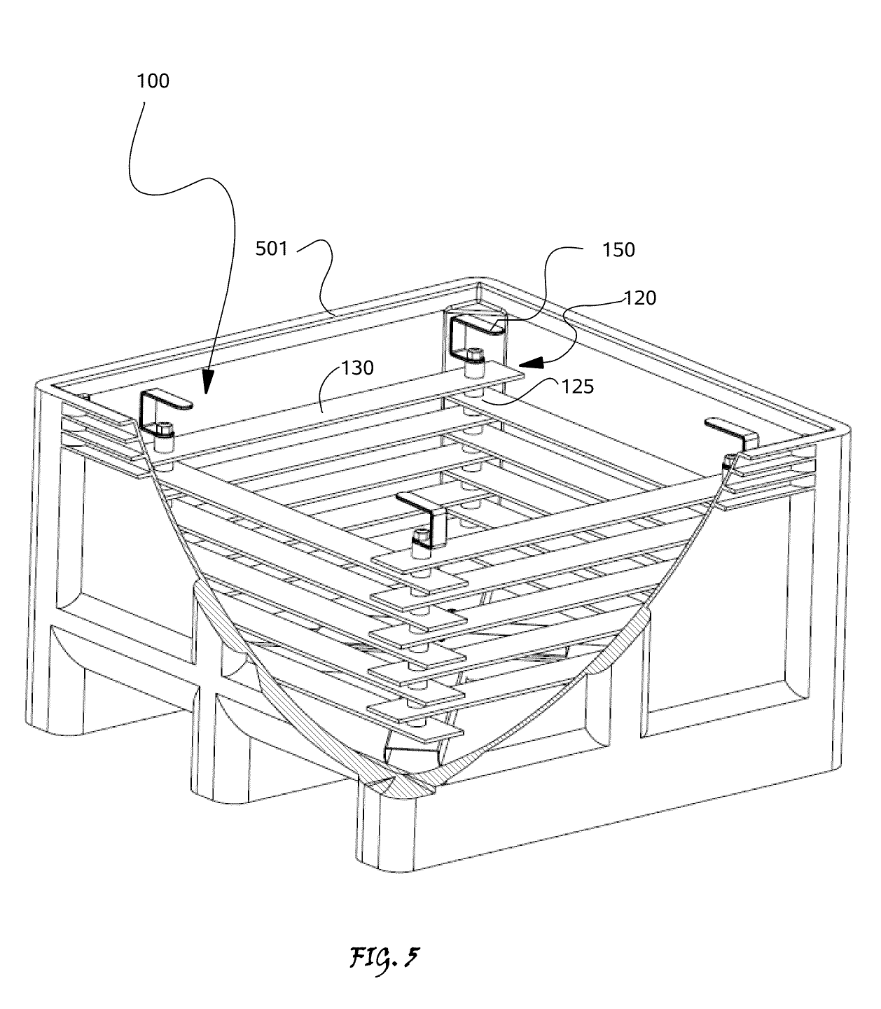

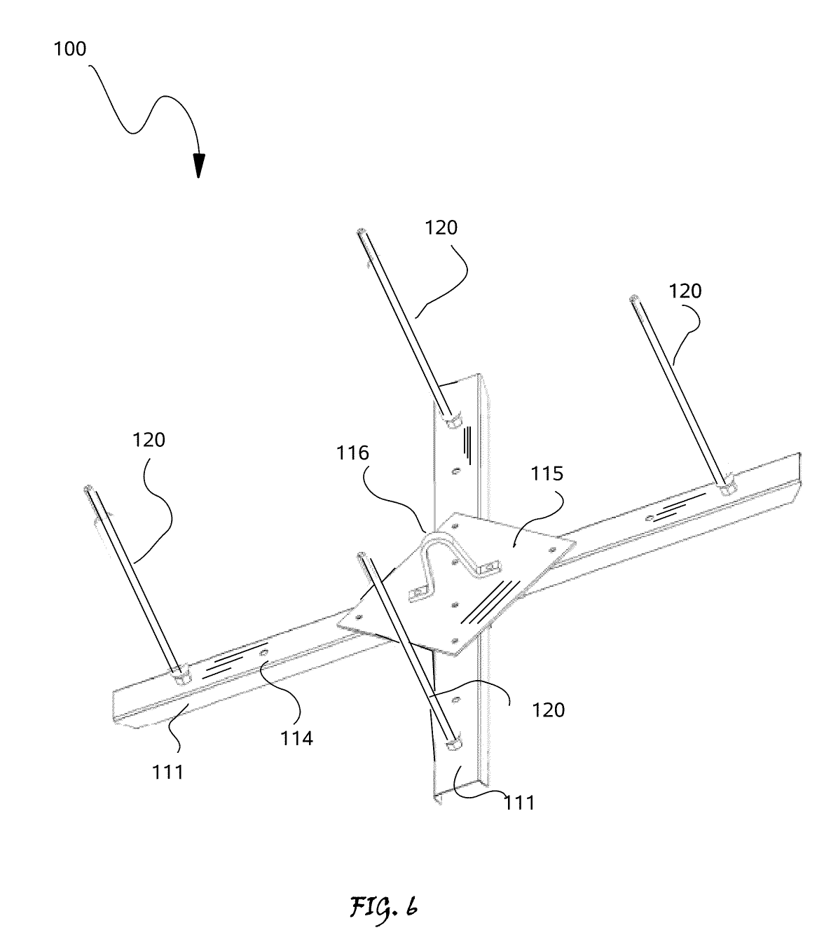

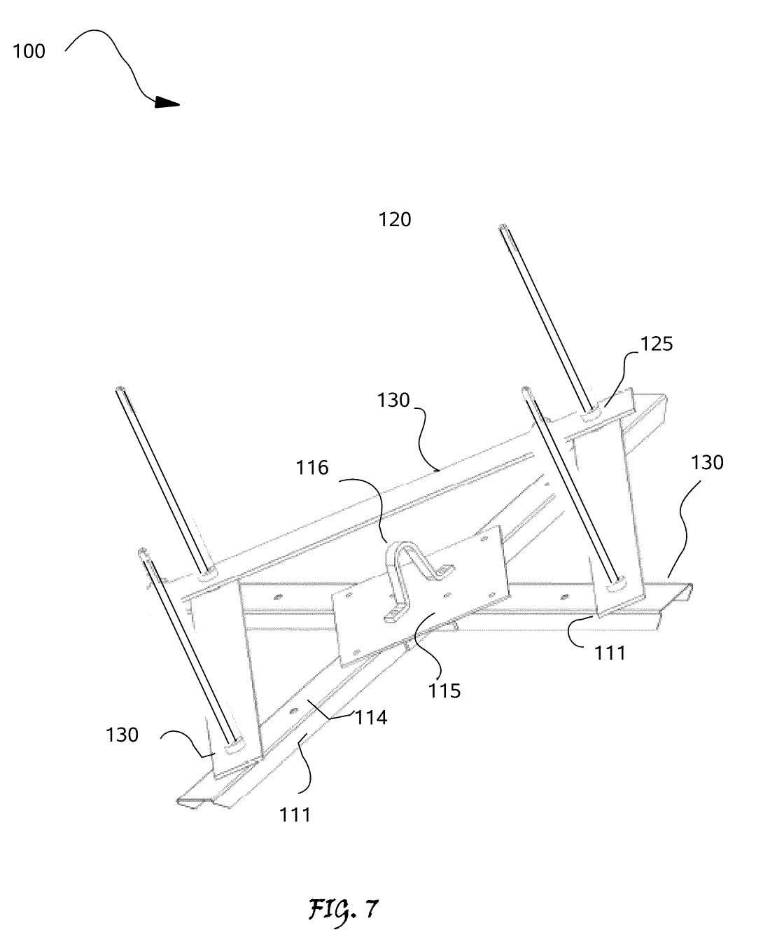

There are various optional means to addition to the planks 130 and columns 120 to grip and remove or insert a frame in a fermentation vessel, such as 501 shown in FIGS. 5, 11 and 12. In FIG. 1, handles 150 are a means to hold the planks 130 submerged in a fluid, as well as a gripping means attached to the frame 100 so as to remove the frame when the treatment or the primary stage of fermentation is complete. The handles 150 would typically either have a threaded hole to screw into a mating thread on the end of each column, or simply have an ordinary hole for the column to pass through so the handle 150 can be held in place by a nut or similar end connector to the column member 120. However, an alternative submerged gripping means may be attached to the base, as illustrated in another embodiment in FIGS. 6 and 7.

The columns 120 can be permanently welded to the base 110, but are preferably connected by threaded fitting for disassembly, cleaning and then storage when not in use, as well as to obtain a more compact state for shipping.

It is preferred that the base 110 has an X-shaped that is formed of 2 or 4 U-shaped beams 111. Preferably, pairs of 2 short beams 112 are linearly joined to form the 2 longer beams 111 that cross. In the embodiment of FIG. 1-4 a pair of shorter and narrower U-shaped beams 113 are joined to cross in their centers and form centrally disposed members 115. Alternatively, as shown in the embodiment of FIG. 6, a plate 115 joins the 2 crossing beams 111.

As for the embodiments of FIG. 1-4, the sides of upper narrower beam 113′ preferably has 2 or more holes in the opposite sides to optionally provide a lifting means, such as a crossing rod that can be grasped by a hook.

In the embodiment of FIG. 6, the base plate 115 with inverted U shaped handle 116 that is capable of being lifted by a hook.

In either case, the crossing beams 111 are preferably mutually connected to central member 115 at several points to provide sufficient stability.

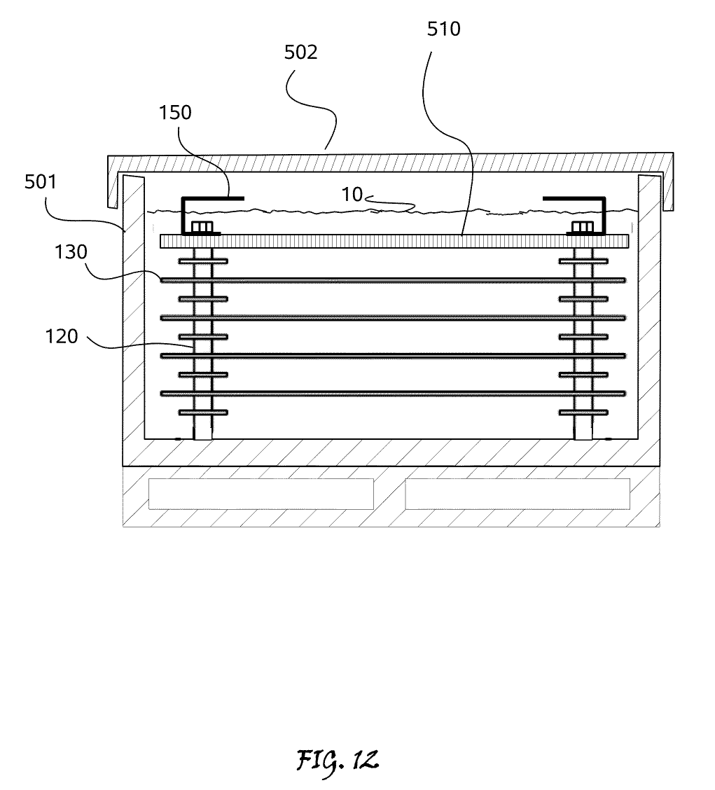

In the embodiment shown in FIG. 12, the base 110 is a perforated plate 510 and the device is inverted in vessel 110 such that the perforated plate will retain a cap that forms in fermentation below the surface of the grape juice/wine mixture during fermentation.

It is also preferred in either embodiment to deploy spacers 125 between vertically adjacent planks 130. The spacers 125 act as thick washers, being generally but not exclusively cylindrical and having an internal diameter greater than the outer diameter of the columns 120, and an outer diameter greater than that of the holes 131 and 132 in the plank 130. The proper vertical spacing of the planks 130 minimizes or prevents grape solids from becoming stuck and non-circulating, and hence difficult to clean, and is preferably comparable the thickness of the planks, that is about 5/16″ (8 mm).

Further , in addition to providing holes in the base components 111, 112 and 113 for attachment via nuts and bolts to other base components, as well as the columns 120, it is also preferred to provide addition hole 114 therein to allow fluid flow and hence decrease resistance to inserting or removing the base 110 to or from a partially filled fermentation or flavoring vessel 501.

The frame assembly of FIG. 1 is deployed in a method of making wine having the following steps: providing a vessel 501 capable of retaining fluid, inserting the plank supporting rack 100 in the vessel 501, filling the vessel 501 with grape must 10, and fermenting the grape must in the presence of the rack to extract tannins from the wood and flavor the wine.

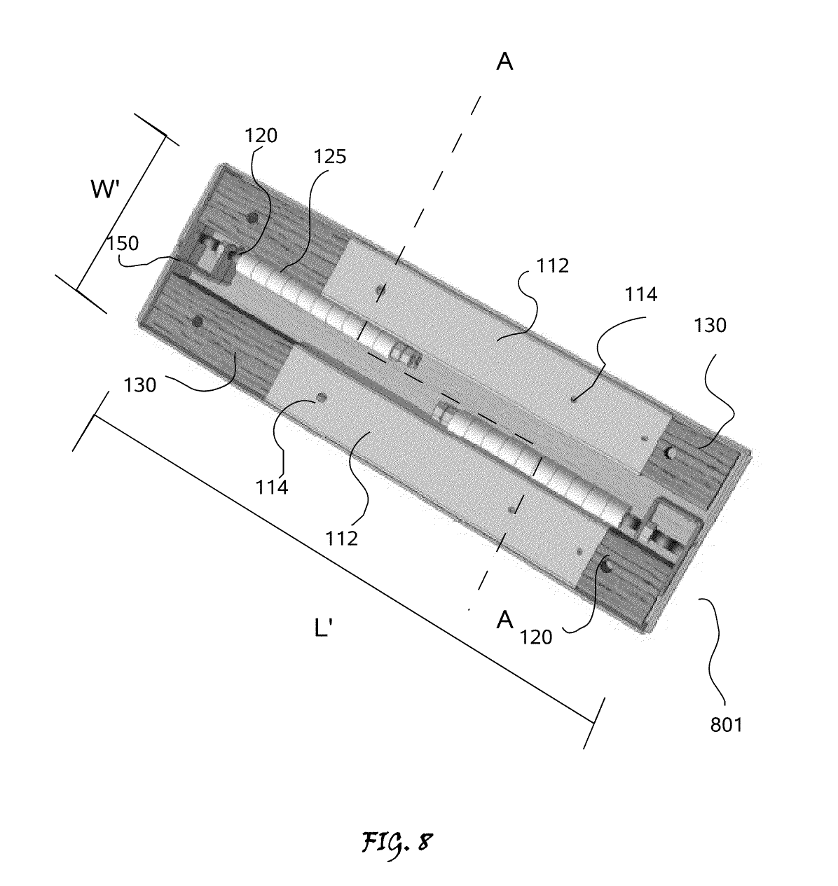

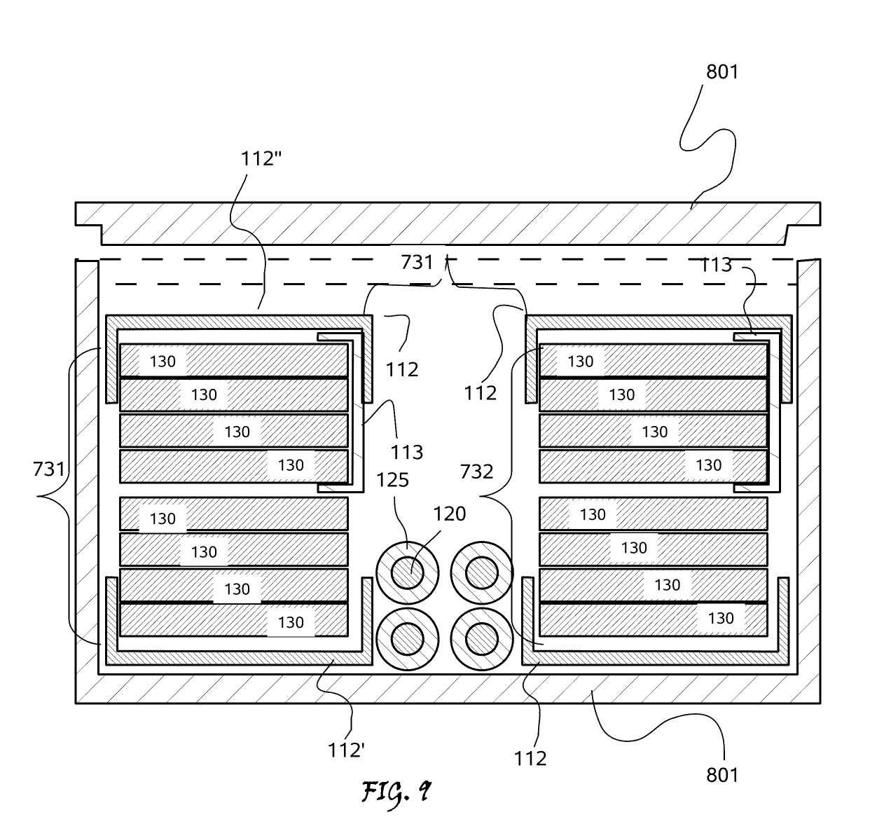

Another aspect of the invention is provide the disable components of the frame assembly 100 as a kit 800, as illustrated in FIGS. 8 and 9, that is preferably disposed in an optional packing box 801. Such a kit includes general at least 4 columns 120, a plurality of spacers 125, components of the frame base 110, means for attaching frame components , such as nuts 117, as well as washers and the like, or bayonet style or other insertion style connectors and the like.

Another aspect of the invention is providing this kit in a compact storage box in the configuration illustrated in FIGS. 6 and 7, in which the components have been inventively configured for a compact arrangement that offers proper protection during shipment with the need for excess packing material.

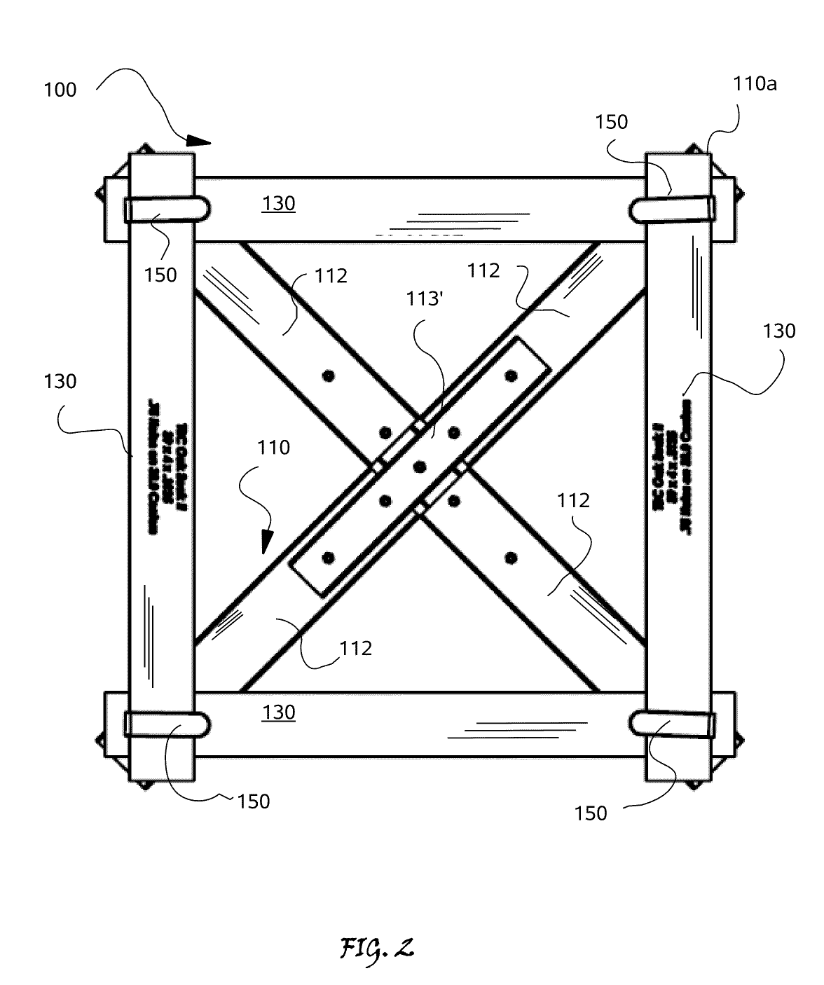

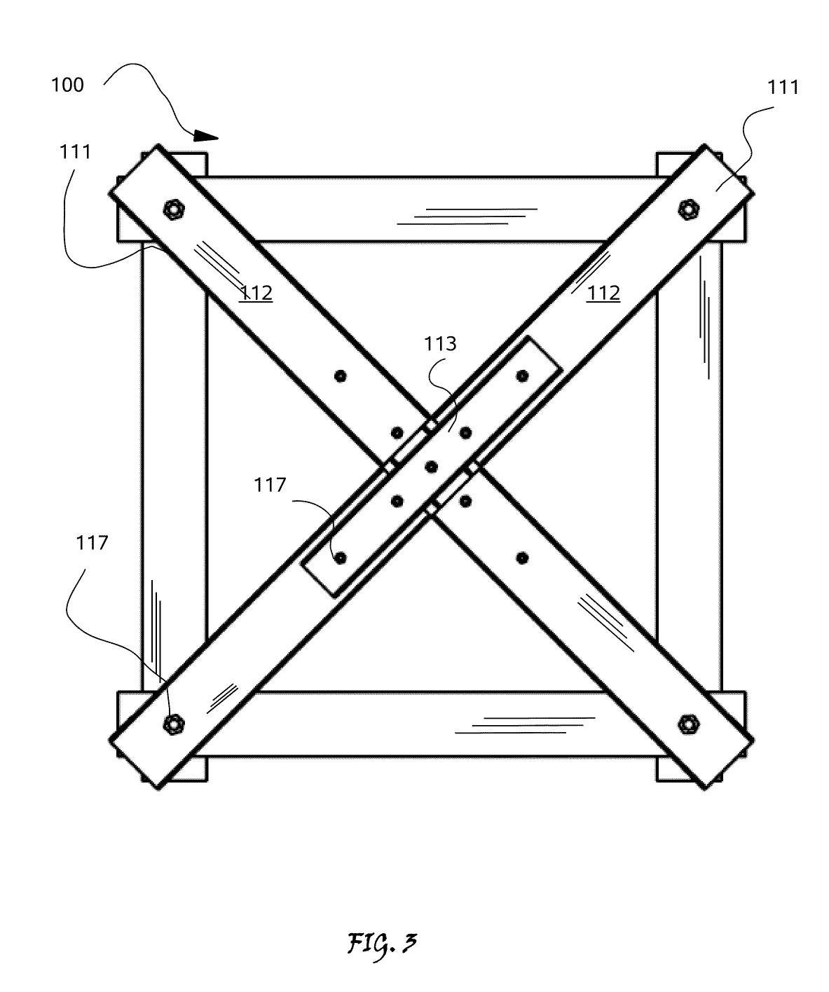

The planks are preferably divided into two stacks, 731 and 732. The support columns 120 are disposed in the space 710 between the 2 stacks of planks U shaped components are partially nested around at least a sub-portion of the stacked planks. In a more preferred embodiment deploying the U shaped components 112 and 113 shown on FIGS. 2 and 3, the base forming components 112 have a gap between the upward arms of the U that is slightly wider than the planks with to fit over the stacks 731 and 732, preferably with the lower component 112′ facing upward and the upper components 112″ facing downward to engage the planks 130 of the stacks 731 and 732. Further, U shaped components 113 are preferably oriented with the bottom face in the middle of the U shape oriented vertically to seat a plurality of the planks 130 with the gap between the arms of the U, which are then oriented horizontally.

Further, the outer packing box 801 preferably has an internal length L′ adapted to supporting receive the length of the stacked planks 130 as well as width W′ adopted to receive the width of the stacked planks and the space or gap 731 between filled with the support columns 120, including optional spacers 125 and handles 150, as well as an joining components 117, and optionally instructions, spare parts and the like therein. It should be appreciated that the columns 120 can be formed of multiple segments that joint together and similarly fit within gap 731. Further, box 801 has a fitted lid 802 that engagingly seals the open upper side above stacks 731/731 and gap 731 for storage and/or shipment.

Another aspect of the invention is the provisional of wood, and particularly toasted oak planks in a format suitable for ready assembly into the frame 100. This wood can be a part of the kit illustrated and described with respect to FIGS. 6 and 7, or as replacement wood planks 130 after the original planks have lost the flavor components from prior use. In order to fit frame 100 in a substantial portion of a currently favored ¼, ½, and 1 ton rectangular fruit bins as vessel 501, the oak planks preferably have a width of about 3-6 inches, and a length of about 38 to 41 inches, and a thickness of about ¼ inch to 1 inch, and preferably about 5/16″. A pair of circular holes 131 and 132 formed at opposite ends of each plank, wherein the center of the hole is displaced from the end of the plank by a distance about equal to about half the width of the planks This placement of hole 131 and 132 enables the preferred space filling vertical stacking arrangement described above. The planks 130 are preferably solid oak and more preferably solid oak that has been toasted.

It should be note that the deployment of spaces 125 between vertically adjacent planks 130 allows extraction of flavor components from both sides of the planks for the entire length, as the grape juice must/wine can readily flow over the entire surface but for a small area at the perimeter of the holes 131 and 132.

It should be appreciated that such a frame 100 is preferably fabricated of food grade stainless steel alloy, but for the wood planks 130.

It should be appreciated that any cap that forms during fermentation can be readily “punched down” in the central area between the stacked planks, as well a pumped over. However, due to the stacking arrangement, it is still possible to expose fluid product in ¼, ½, and 1 ton fruit bins to the same area of oak as the much smaller 50-60 gallon barrels, yet without the expense, rarity, and other issues associated therewith.

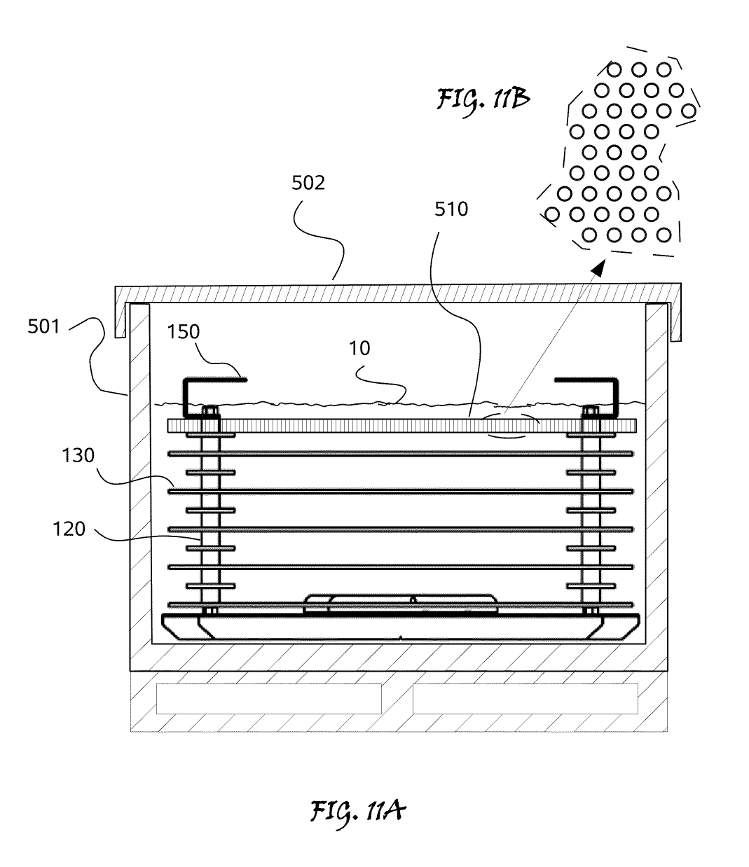

As shown in FIG. 11 and 12 the frame 100 can be used with a porous plate 510 extending to cover the central area between the stacked planks which then acts as a cap submersion means. The porous plate 510 has large number of gaps, holes or apertures as shown in FIG. 11b and 12B to provide for upward fluid flow and the retention of grape solids below. The plate 510 is optionally held at the corners to the columns 120, just like planks 130 and/or spaces 125, that is bellow handle 150 or similar means deployed at the top of the columns to retains planks. Alternatively, further planks 130 or wood bars, mesh or lattice can be disposed across central area above the stacked planks and function as a cap submersion means. Such a layer of a plurality of planks or elongated wood members can be spaced apart to have a plurality gaps to provide for upward fluid flow and solid retention below. Plate 510 or such a collection of planks and/or wood bars, mesh or lattice can be disposed just below the last layer of the stacked planks, which provides a means for retention to submerge the cap that is not attached directly to the columns 120.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

1) An assembly for flavoring wine during fermentation, the assembly comprising:
a) a laterally extending base having at least 3 vertices,
b) a plurality of columns extending upward from the base at a position proximal to a vertex thereof,
c) a plurality of longitudinally extending wooden planks having holes on opposing ends, said planks being disposed horizontally and supported in a stacked arrangement by adjacent pairs of said columns, which extend through the holes thereof to provide a plurality of adjacent stacks, each adjacent stack disposed laterally above a chord of the base defined by the distance between adjacent vertices,

2) The assembly for flavoring wine during fermentation according to claim 1, and further comprising plurality of spacers insert over the outside of the columns for separating adjacent planks in a stack.

3) The assembly for flavoring wine during fermentation according to claim 2, and further comprising:
a) a gripping means attached to at least one of the base or frame,
b) a means for holding the planks submerged in a fluid.

4) The assembly for flavoring wine during fermentation according to claim 1, wherein the planks in adjacent stacks are vertically interlaced at common columns associated with each vertex.

5) The assembly for flavoring wine during fermentation according to claim 1, wherein the base has an X-shape to provide 4 vertices, in which each vertex is at an end of a cross arm that form the X-shape.

6) The assembly for flavoring wine during fermentation according to claim 5, wherein X-shape of the base is formed of 2 or more U-shaped beams that are horizontally disposed.

7) The assembly for flavoring wine during fermentation according to claim 6, wherein pairs of 2 short U-shaped beams are linearly joined to form 2 longer U-shaped beams which cross to form the X-shaped base.

8) The assembly for flavoring wine during fermentation according to claim 7, in which a horizontally disposed plate joins the crossing U-shaped beams at a center of the X-shape.

9) The assembly for flavoring wine during fermentation according to claim 6, in which a one pair of 2 short U-shaped beam are joined at the center by a horizontal connecting member the longer U-shaped beam formed of the other pair of shorter U-shaped beams passes under to the horizontal connecting member.

10) A process for fermenting grape must, the process comprising the steps of:
a) providing a rectangular vessel capable of retaining fluid,
b) introducing the frame of claim 1 in the vessel,
c) filling the vessel with grape must,
d) fermenting the grape must in the presence of the rack to extract tannins from the wood and flavor the wine the is the product of said step of fermenting.

11) A kit for assembling a wine flavoring insert, the kit comprising:
a) components for assembling a laterally extending base having at least 3 vertices,
b) a plurality of columns, each column in the plurality having means for coupling with the base to extend upward therefrom proximal to a different vertex of the base,
c) a plurality of longitudinally extending wooden planks having holes on opposing ends, said planks being configured for assembly horizontally and supported in a stacked arrangement by adjacent pairs of said columns, which are configured to extend through the holes thereof after assembly of the kit.

12) The kit for assembling a wine flavoring insert according to claim 11, wherein the components for assembling the laterally extending base are a plurality of U-shaped beam members.

13) The kit for assembling a wine flavoring insert according to claim 12, further comprising a box into which are packed the components of the kit, in which the plurality of longitudinally extending wooden planks are subdivided into at least 2 stacks, and at least one or more stacks is nested with a U-shaped beam member component for assembling the laterally extending base.

14) The kit for assembling a wine flavoring insert according to claim 12, wherein the box has an internal length adapted to supportingly receive a long axis of the stacked planks and width adopted to receive twice the short axis of the stacked planks with addition width for receiving the plurality of support columns when aligned with a long axis thereof oriented parallel to the long axis of the stacked planks

15) The kit for assembling a wine flavoring insert according to claim 14 in which the planks are arranged in 2 stacks and each stack is disposed at opposite sides of the box and the plurality of support columns are disposed between the stacks of planks

16) The kit for assembling a wine flavoring insert according to claim 15 in which at least some of the U-shaped beam member components that nestingly receive each of the pairs of stacks are disposed between the stacked planks and the support columns.

17) The kit for assembling a wine flavoring insert according to claim 11, in which the plurality of longitudinally extending wooden planks are subdivided into at least 2 stacks, and at least one or more stacks is nested with a pair of U-shaped beam member component for assembling the laterally extending base, wherein each U-shaped beam member component in the pair is disposed on opposite sides of the stacked planks such that edges of multiple planks contact the bottom of the U-shape between arms of the U-shape.

18) The kit for assembling a wine flavoring insert according to claim 11, wherein the components for assembling a laterally extending base are adapted for connecting to form an X-shape to provide 4 vertices, in which each vertex is at an end of a cross arm that form the X-shape.

19) The kit for assembling a wine flavoring insert according to claim 11, further comprising a plurality of spacers having a central bore sized to received the columns for disposal between adjacent planks upon assembly into the wine flavoring insert.

20) The kit for assembling a wine flavoring insert according to claim 11 wherein a plurality of the planks have a pair of circular hole formed at opposite ends thereof, wherein the center of the hole is displaced from the end of the plank by a distance about equal to about half the width of the planks
